(19) United States
(12) Patent Application Publication
(10) Pub. No.: US 2008/0275373 A1
(43) Pub. Date: Nov. 6, 2008

(54) Fitness Machine Having a Vibration Absorbing Support

(75) Inventor: Augustinus Leonardus Nicolaas van der Meer, Hoofddorp (NL)

Correspondence Address: PAUL, HASTINGS, JANOFSKY & WALKER LLP, 875 15th Street, NW, Washington, DC, 20005, US

(73) Assignee: PPNA ACQUISITION LLC

(21) Appl. No.: 12/065,700

(22) PCT Filed: Sep. 6, 2005
(86) PCT No.: PCT/NL2005/000642

§ 371 Date: Jul. 10, 2008

(51) Int. Cl. A61H 1/00

(52) U.S. Cl. 601/49

(57) ABSTRACT

The present invention relates to a fitness machine (1) for training the body, comprising a frame (2) with a vibration element (3), a vibration generator (4) operatively connected to the vibration element (3). The vibration element (3) is supported by vibration absorbing frame supports (9). Adjusting an absorption level of the frame supports (9) enables to set the vibration absorption in such a way that vibrations of the vibration element (3) are damped to a selected degree, as a result of which a training load desired by the user can be obtained.

The present invention relates to a fitness machine for training a body comprising a frame with a vibration element, a vibration generator operatively coupled to the vibration element and at least one vibration-absorbing frame support operatively coupled to the vibration generator.

Such a fitness machine has been known since back in the nineteen sixties and is often used by such people as top sports players and persons recovering from an injury.

The known fitness machine of the above-mentioned type is put on the market, inter alia, under the name of Power Plate®; by Power Plate International, Badhoevedorp, The Netherlands. This known fitness machine is in the form of a vibrating plate placed on a frame positioned low down, close to the ground, in the case of which a user can go and stand on the vibrating plate, or can assume other positions, during the training. The vibrating plate in this case generates vibrations, which are mechanically transmitted as energy to the user's body. The mechanical stimulus generated as a result produces a so-called stretch reflex in the muscles of the body, which stretch reflex occurs a certain number of times per second depending on the set frequency of the vibrating plate. The result of this is that the muscles are continuously tensed very hard.

It has been found that the use of such a vibrating plate produces a very great effect when used for a short training period, and there is less strain on the locomotor system than is the case with conventional training methods. Beneficial effects of vibrating stimulation of the body are described in, inter alia, the Journal of Sports Sciences, 1999, 17, pp. 177-182.

A problem in the case of the above-mentioned known type of fitness machine is that the training load cannot be varied to the desired degree, more in particular, the training load cannot be adjusted with respect to the body mass of a user. In the known fitness machine, the vibrating plate is supported by a flexible support, such as a spring or the like. The vibration of the vibrating plate is damped by the flexible support. An amount of damping is determined by the tension on the flexible support. Since the tension of the flexible support is not adjustable, the training load on the body is high, if the mass of the body on the vibrating plate is low. If the mass of the body is high, the training load is low. Thus, a lightweight user being out of condition is provided with a heavy training load, whereas a user being in condition and having a large body mass is provided with a low training load.

It is an object of the present invention to provide a fitness machine having an adjustable training load.

The present invention provides a fitness machine for training a body comprising a frame with a vibration element, a vibration generator operatively coupled to the vibration element and at least one vibration-absorbing frame support operatively coupled to the vibration generator, wherein an absorption level of the at least one vibration absorbing frame support is adjustable.

In an embodiment, the absorption level, i.e. degree of damping, of the frame support depends on a tension in the vibration-absorbing frame support. Since the vibration absorption by the frame support is determined by the tension of the frame support, it is possible to adjust the vibration damping by adjusting the tension of the frame support, as a result of which a training load desired by the user can be obtained.

The fitness machine according to the invention makes it possible to adjust the training load to the requirements of a user. Thus, the training load may be set independent of the body mass. This is particularly advantageous if the fitness machine is being used in, for example, a sports college, where different people with different training loads are using one and the same fitness machine.

A frame of a fitness machine according to the invention can be designed in many ways. The frame generally serves to accommodate the vibration element, the vibration generator operatively coupled to the vibration element and the frame support operatively coupled to the vibration generator.

A vibration generator of the fitness machine according to the invention can be designed in many ways, as long as the envisaged effect, i.e. producing a vibration of the vibration element, can be produced.

The person skilled in the art will readily understand what is meant by ‘training load’, namely the intensity of the exercise being performed on the fitness machine according to the invention. As mentioned above, the muscles of a body positioned on the vibration element are tensed by the vibrations. The intensity of the exercise, i.e. the training load, is determined by the number of stretch reflexes (the frequency of the vibration) and the intensity of the stretch reflex (the amplitude of the vibration). The training load of the fitness machine according to the invention may be in principle adjustable over a wide range by providing an adjustable frequency and/or adjustable amplitude of the vibration.

In an embodiment, the vibration element preferably comprises a plate which extends substantially horizontally. This enables the user to assume a comfortable position, such as standing, sitting or lying on said plate, during the training on the fitness machine according to the invention. The plate of the vibration element can have any desired cross-section, e.g. round or rectangular.

In an embodiment of the fitness machine according to the invention the frame may comprise a support which the user can grip. The support may comprise a display on which training data can be shown.

In an embodiment the fitness machine further comprises a control system for controlling the vibration absorption of the frame support in response to a body mass of the body. When a user is positioned on the vibration element, the control system may automatically determine that the absorption level of the frame support is changed and may set the absorption level of the frame support at a desired level. Thereto, the user only needs to indicate a desired training load. The control system may then control the absorption level of the frame support to provide the desired training load.

A suitable frame support is a gas-filled bellows. Means for adjusting a gas pressure of a gas contained in said bellows are then provided to change the gas pressure of the gas contained in the bellows, thereby changing the absorption level of the bellows by changing the tension in the bellows. Suitable means are for example a gas pump, or the like. The gas may be air, for example.

The invention will be explained in greater detail below with reference to a non-limiting drawing, in which:

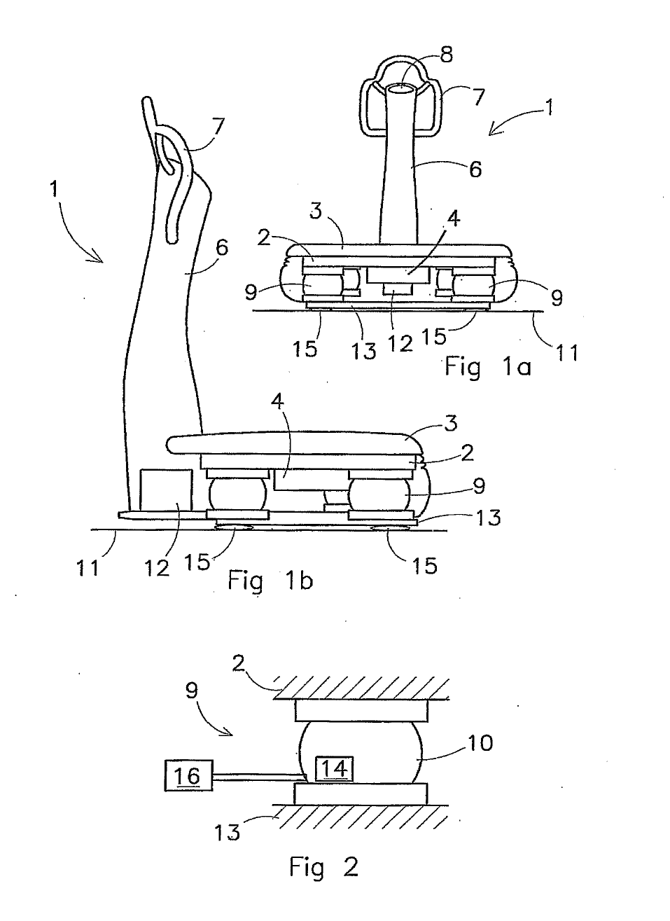

FIGS. 1A and 1B show a diagrammatic view of an embodiment of a fitness machine according to the present invention illustrating outlines and internal devices of the fitness machine; and

FIG. 2 shows a cross-sectional view of an embodiment of a vibration absorbing frame support of the fitness machine according to FIG. 1.

The same reference numerals refer to identical parts.

FIGS. 1A and 1B show a fitness machine for training the body by means of vibrations, which fitness machine in general is indicated by reference numeral 1. The fitness machine 1 comprises a frame 2 with a vibration element 3 coupled thereto and a vibration generator 4 operatively connected to the vibration element 3 or the frame 2 such that a vibration generated by the vibration generator 4 is mechanically transmitted to the vibration element 3. In the embodiment shown the vibration element 3 is designed in the form of a plate extending substantially horizontally.

In the shown embodiment, the vibration generator 4 is attached to the frame 2 or the vibration element 3. A suitable vibration generator 4 may be an eccenter motor, for example. Another suitable type of vibration generator 4 may be used as well. A person skilled in the art will readily understand that a suitable vibration generator 4 may be positioned on a base frame 13 (which is described hereinafter) and using a suitable connection to generate a vibration in vibration element 3. In an embodiment, the vibrations generated by the vibration generator 4 may be controlled with respect to a frequency and/or amplitude for controlling a training load.

The fitness machine 1 further comprises vibration absorbing frame supports 9. The frame supports 9 support the frame 2 and the vibration element 3. The frame supports 9 can absorb vibrations produced by the vibration generator 4 and mechanically transmitted to the vibration element 3 and the frame 2 to a selected degree of absorption, as a result of which a training load desired by a user can be obtained. In particular, in an embodiment of the frame supports 9, a tension of the frame supports 9 may be adjustable in such a way that a desired amount of vibrations is absorbed during operation as is further explained hereinafter.

The fitness machine 1 further comprises a standing support 6, which is provided with a handgrip 7, which the user can grip during the training. The support 6 is further provided with a display 8 operatively coupled to a control system 12 on which training data, such as training duration, frequencies used etc., can be read. The fitness machine 1 may comprise further devices (not shown), such as a power supply. The control system 12 may comprise a controller for controlling at least one of the vibration generator 4 and the frame supports 9. The controller may control the vibration generator 4 to generate vibrations having a frequency and/or amplitude corresponding to a user setting, for example. The frame supports 9 may be controlled to have an absorption level corresponding to a body mass of a body positioned on the vibration element 3, for example, as explained in further detail below in relation to FIG. 2.

The fitness machine 1 may be positioned on a floor 11. For example, the vibration-absorbing frame supports 9 are positioned on the floor 11. In an embodiment, the fitness machine 1 may be provided with a base frame element 13. In such an embodiment the frame supports 9 may be located between the base frame 13 and the vibration element 3 or the frame 2. The base frame 13 may support the standing support 6 as well. On an underside of the base frame 13 rubber feet 15, for example, may be provided to protect a floor surface on which the fitness machine 1 is positioned.

When using the fitness machine 1 a user may go and stand on the vibration element 3 and grip the handgrip 7 on the standing support 6. In this case the vibrations generated in the vibration element 3 by the vibration generator 4 are absorbed by the muscular system of the user's body, which results in the desired stretch reflexes in the body muscles. It is noted that other positions of the body, instead of standing, may be used as well depending on the muscles to be trained.

FIG. 2 illustrates an embodiment of a frame support 9 according to the invention. The shown frame support 9 is a gas-filled bellows 10. The gas pressure of the gas contained in the bellows 10 determines the amount of vibration absorption of the frame support 9. The gas pressure may be adjusted using a device 16. The device 16 for adjusting the gas pressure inside the bellows 10 may be a pump or the device 16 may comprise a chamber connected to the interior of the bellows 10. The size of such a chamber of device 16 may then be adjustable, thereby influencing the gas pressure inside the bellows 10 and the chamber of the device 16. A person skilled in the art readily understand that any other device 16 suitable to adjust the gas pressure in the bellows 10 may be used as well.

Now referring to FIGS. 1A, 1B and 2, the device 16 for adjusting the absorption level of the frame support 9 may be controllable through the control system 12. The display 8 may comprise a user-input device. The user may use the user-input device for indicating a desired training load. The control system 12 converts the indicated desired training load to a desired absorption level or gas pressure of the frame supports 9. If the device 16 comprises a chamber as described above, thereby providing a closed system, the size of the chamber may be controlled by the control system 12. If an open system is provided, for example using a pump, a pressure sensor 14 may be provided in the bellows 10. The pressure determined by the sensor 14 is then supplied to the control system 12. In response to the received pressure, the control system 12 controls the device 16 until the desired pressure is obtained.

In another embodiment, the control system 12 may be configured to control the vibration generator 4 in response to the user-input indicating a desired training load. The absorption level of the frame supports 9 may be controlled, separately, by the same or another control system, in response to a body mass of the user. An advantage of such an embodiment is found in the user-friendly control. The user-input device may provide a simple interface such that the user may select a training load level, which corresponds to a predetermined frequency and amplitude of the vibrations to be generated by the vibration generator 4. The selectable training load levels are substantially equal for each user, since a difference in user body mass is compensated by a correspondingly different absorption level of the frame supports 9.

The person skilled in the art will readily understand that the invention can be varied in many ways without departing from the scope of the invention.

1. Fitness machine (1) for training a body comprising a frame (2) with a vibration element (3), a vibration generator (4) operatively coupled to the vibration element (3) and at least one vibration-absorbing frame support (9) operatively coupled to the vibration generator (4), an absorption level of the at least one vibration-absorbing frame support (9) being adjustable, and wherein the fitness machine comprises
a control system for controlling the vibration generator (4) in response to a user-input indicating a desired training load and
a control system (12) for controlling the absorption level of the vibration-absorbing frame support (9) in response to a body mass of a user positioned on the vibration element (3) such that the selectable training load levels are substantially equal for each user.

2. Fitness machine (1) according to claim 1, wherein the control system (12) for controlling the absorption level of the vibration-absorbing frame support (9) is configured to compensate a difference in the body mass of a user by a correspondingly different absorption level of the frame supports 9.

3. Fitness machine (1) according to claim 1 or 2, wherein the control system (12) for controlling the absorption level is configured for controlling the vibration generator (4).

4. Fitness machine (1) according to any of claim 1-3, wherein the absorption level of the at least one vibration-absorbing frame support (9) depends on a tension in the vibration-absorbing frame support (9), the tension in the vibration-absorbing frame support (9) being adjustable.

5. Fitness machine according to claim 4, wherein the vibration-absorbing frame support (9) comprises a gas-filled bellows (10) and a device (16) for adjusting the gas pressure of the gas contained in said bellows (10).

6. Fitness machine according to claim 5, wherein the device (16) for adjusting the gas pressure comprises a gas pump.

7. Fitness machine according to claim 5, wherein the gas is air.
